(19) United States
(12) Patent Application Publication
(10) Pub. No.: US 2018/0192132 A1
(43) Pub. Date: Jul. 5, 2018

(54) SYSTEM AND METHOD FOR SELECTING SPORTS AND TEAMS OF USER'S INTEREST

(71) Applicant: Joshua Denton, Sharon, PA (US)

(72) Inventor: Joshua Denton, Sharon, PA (US)

(21) Appl. No.: 15/397,729

(22) Filed: Jan. 4, 2017

(51) Int. Cl. H04N 21/45; H04N 21/475

(52) U.S. Cl. CPC H04N 21/4532; H04N 21/4755; H04N 21/4753

(57) ABSTRACT

A method of selecting user's interest sports and teams in a broadcasting network for customized broadcasting for a user is provided. The method includes following steps: (i), the user is logged in to the broadcast network to select sports; (ii) the sports are selected according to the user's interest from the broadcasting network; (iii) teams of the sports are selected according to the user's interest from the broadcasting network; (iv) the selected sports and selected teams are compared with the broadcasting network to check whether the selected sports and selected teams are available online or not; and (v) (a) a live match of a sport from the selected sports and teams or else (b) recorded match of a sport from the selected sports and teams according to the user's priorities of the selected sports and teams are displayed on a user computing device.

### BACKGROUND

### Technical Field

The embodiments herein generally relate to an on-demand broadcasting system, and more particularly, a system and method for selecting one or more sports and teams of user's interest.

### Description of the Related Art

Recently, in the field of television broadcast, ground wave broadcast and satellite broadcast are being digitized and partly realized. Some of the people are very much interested in the sports, but the people may not be aware of schedule of particular sport. A user pays for all the channels, including the ones the user is interested in, and the ones the user is not interested. For example, a user is interested in basketball game of United States team, but the user may not be aware about the schedule of the basketball game and hence miss a match. Moreover, the user may also not be aware of the channel on which the basketball game is being broadcasted. So, the user needs to view all the channels to find a particular channel that broadcasts the basketball game. The user can't watch the match again and again.

Accordingly, there remains a need for an effective system and method for selecting one or more sports and teams of user's interest and watch for one or more times.

### SUMMARY

In view of the foregoing, an embodiment herein provides an on-demand sports broadcasting system for selecting a plurality of user's interest sports and teams in a broadcast network with a small fee instead of big packages. The on-demand sports broadcasting system includes a memory unit, a processor, and a display unit. The memory unit stores a database, and a set of program modules. The processor process the set of program module. The set of program modules includes a login program module, a sport selection program, a team selection program module, a processing program module, and a control program module. The login program module is configured to allow said user to login into the on-demand broadcasting system. The sport selection program module is configured to select one or more sports of the user's interest and set priorities for the one or more sports.

The team selection program module is configured to select one or more teams of the plurality of selected sports and set priorities for the one or more teams. The processing program module is configured to compare the one or more selected sports, and the one or more selected teams with broadcasting network to check whether the one or more selected sports and the one or more selected teams are available online or not. The control program module is configured to play (i) a live match of a sport from the one or more selected sports and teams or else (ii) recorded match of a sport from the one or more selected sports and teams according to the priorities of the one or more selected sports and teams. The display unit is configured to display (i) a live match of a sport from the one or more selected sports and teams or else (ii) recorded match of a sport from the one or more selected sports and teams according to the priorities of the one or more selected sports and teams on a user computing device.

In another aspect, a method of selecting one or more user's interest sports and teams in a broadcasting network for customized broadcasting for a user is provided. The method includes following steps: (i), the user is logged in to the broadcast network to select one or more sports; (ii) the one or more sports are selected according to the user's interest from the broadcasting network; (iii) one or more teams of the one or more sports are selected according to the user's interest from the broadcasting network; (iv) the one or more selected sports and selected teams are compared with the broadcasting network to check whether the one or more selected sports and selected teams are available online or not; and (v) (a) a live match of a sport from the one or more selected sports and teams or else (b) recorded match of a sport from the one or more selected sports and teams according to the user's priorities of the one or more selected sports and teams are displayed on a user computing device.

In one embodiment, the method further includes steps of (a) the one or more sports are prioritized according to the user's preference; and (b) the one or more teams of the one or more sports are prioritized according to the user's preference.

In yet another aspect, a non-transitory program storage device readable medium by a computer, and including a program of instruction executable by said computer to perform a method of selecting one or more user's interest sports and teams in a broadcasting network for customized broadcasting for a user is provided. The method includes following steps: (i), the user is logged in to the broadcast network to select one or more sports; (ii) the one or more sports are selected according to the user's interest from the broadcasting network; (iii) one or more teams of the one or more sports are selected according to the user's interest from the broadcasting network; (iv) the one or more selected sports and selected teams are compared with the broadcasting network to check whether the one or more selected sports and selected teams are available online or not; and (v) (a) a live match of a sport from the one or more selected sports and teams or else (b) recorded match of a sport from the one or more selected sports and teams according to the user's priorities of the one or more selected sports and teams are displayed on a user computing device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of an on-demand sports broadcasting system implemented in a user computing device that interacts to a server via a network to select one or more sports, and one or more teams of the one or more selected sports of user's interest according to an embodiment herein;

FIG. 2 illustrates an exploded view of the on-demand sports broadcasting system of FIG. 1 according to an embodiment herein;

FIG. 3A illustrates the user interface view of the welcome screen of the on-demand sports broadcasting system of FIG. 1 according to an embodiment herein;

FIG. 3B illustrates the user interface view of the one or more sports selection screen of the on-demand sports broadcasting system of FIG. 1 according to an embodiment herein;

FIG. 3C illustrates the user interface view of the one or more teams selection screen of the on-demand sports broadcasting system of FIG. 1 according to an embodiment herein;

FIG. 4 is a flow diagram illustrating a method of selecting the one or more sports and teams according to user's interest for customized broadcasting for the user according to an embodiment herein;

FIG. 5 illustrates an exploded view of the computing device of FIG. 1 according to the embodiments herein; and

FIG. 6 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

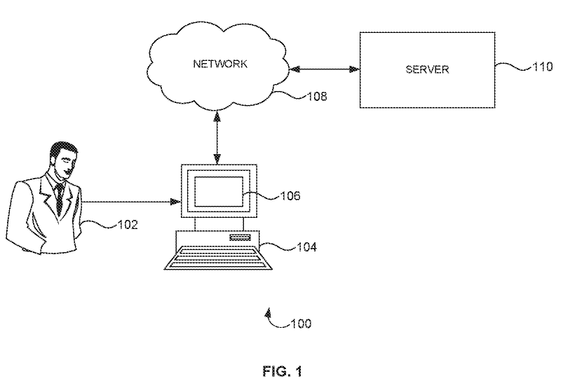

The embodiments herein achieve this by providing a system and method for selecting one or more sports and one or more teams of selected one or more sports of user's interest. Referring now to the drawings, and more particularly to FIGS. 1 through 6, where similar reference characters denote corresponding features consistently throughout the figures, there are shown preferred embodiments.

FIG. 1 illustrates a system view 100 of an on-demand sports broadcasting system 106 implemented in a user computing device 104 that interacts to a server 110 via a network 108 to select one or more sports, and one or more teams of the one or more selected sports of user's interest according to an embodiment herein. The system view 100 includes the user 102, the user computing device 104, the on-demand sports broadcasting system 106, the network 108 and the server 110. The on-demand sports broadcasting system 106 can be implemented in the user computing device 104 that interacts with the server 110 through the network 108 to select one or more sports, and one or more teams of the selected one or more sports of user's interest with a small fee instead of big packages. In one embodiment, the on-demand sports broadcasting system 106 may be implemented in a remote server. In one embodiment, the network 118 may be an internet or a broadcast network.

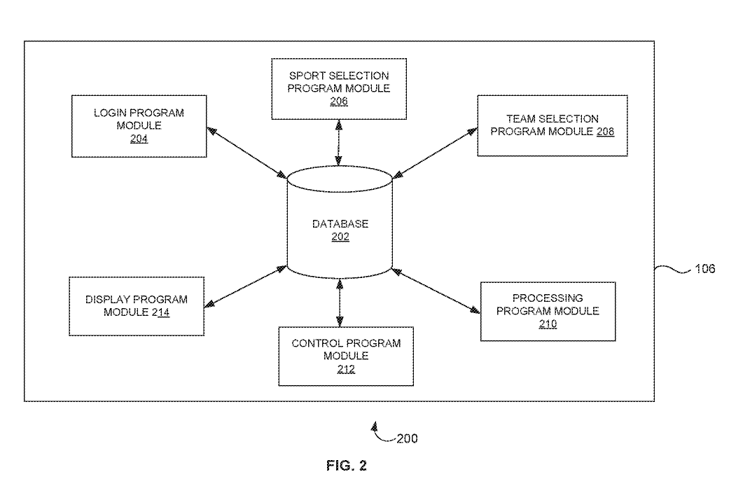

FIG. 2 illustrates an exploded view 200 of the on-demand sports broadcasting system 106 of FIG. 1 according to an embodiment herein. The exploded view 200 includes a database 202, a login program module 204, a sport selection program module 206, a team selection program module 208, a processing program module 210, a control program module 212, and a display program module 214. The database 202 stores a set of program modules and one or more matches of one or more sports. The login program module 204 is configured to allow the user 102 to login into the on-demand sports broadcasting system 106. In one embodiment, the user 102 is assigned a unique user ID, and a user login password. In another embodiment, the user login password can be changed/customized by the user 102. The sport selection program module 206 is configured to allow the user 102 to select one or more sports of user's interest from the broadcasting network. In one embodiment, the sports include, but not limited to, (i) soccer, (ii) rugby, (iii) tennis, and/or (iv) golf.

The team selection program module 208 is configured to allow the user 102 to select one or more teams of the one or more selected sports of user's interest from the broadcasting network. In one embodiment, the user 102 sets a priority of the one or more selected sports and teams of the one or more selected sports to be played in a priority sequence. The processing program module 210 is configured to (i) process the one or more selected sports and teams, and (ii) compare the one or more selected sports and teams with the broadcasting network to check whether the one or more selected sports and teams are available online or not. The control program module 212 is configured to play a live match of a sport from the one or more selected sports and teams or else recorded match of a sport from the one or more selected sports and teams online according to the priority. In one embodiment, the one or more selected sports are available on the broadcasting network for 24 hours or until next match of the one or more selected sports are played which ever earlier.

The display program module 214 is configured to display the match of the one or more selected sports and teams. In other embodiment, the user 102 requires the user ID and login password to login into the on-demand sports broadcasting system 106. For example, if the user 102 sets the priority of sports in a sequence like soccer, rugby then tennis. The priority of teams of the one or more selected sports in a sequence like team A1, A2, A3 for soccer, team B1, B2, B3 for rugby, and team C1, C2, C3 for tennis. So, the on-demand sports broadcasting system 106 gives first preference to the soccer and in soccer first preference is given to the Team A1 to play on the user computing device 104. If no match of Team A1 of the soccer is available on broadcasting network, then preference is given to the Team A2 of the soccer. If match of both Team A1 and A2 is not available then the preference is given to the Team A3 of the soccer. In case, if no soccer match is available or no selected teams are playing soccer on the broadcasting network then the rugby match is played on the user computing device 104. In rugby first preference is given to the Team B1, then Team B2 and then to Team B3. If match of both soccer and rugby are not available on the broadcasting network, then the tennis is played on the user computing device 104. Similarly in tennis, first preference is given to Team C1, then Team C2 and then Team C3.

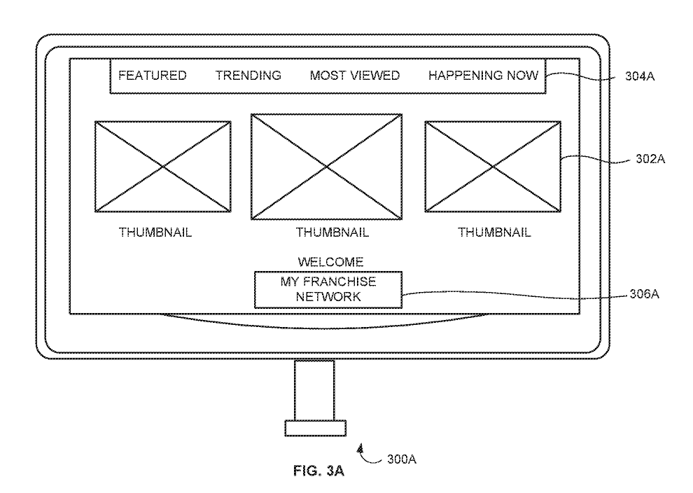

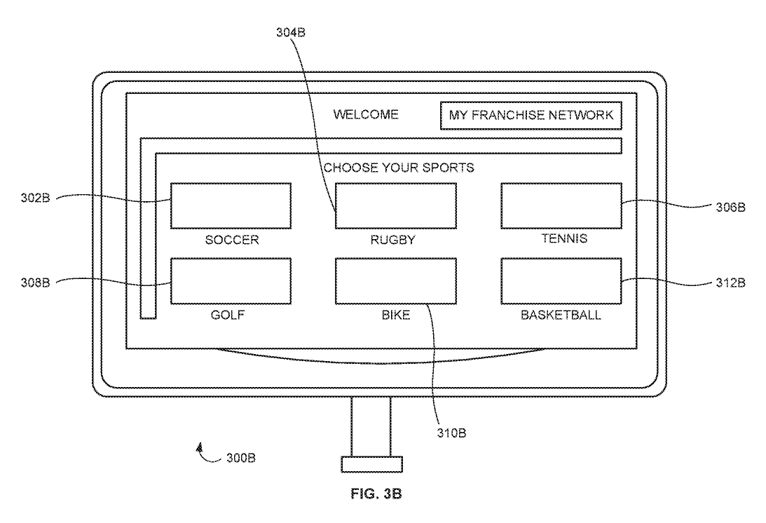

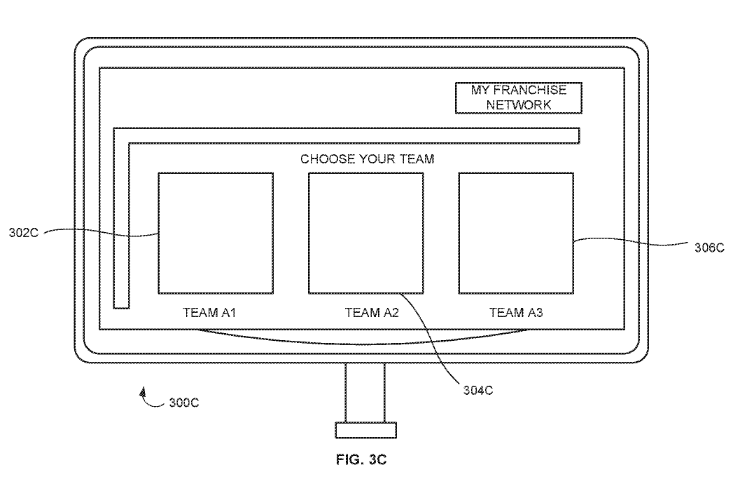

FIG. 3A illustrates the user interface view 300A of the welcome screen of the on-demand sports broadcasting system 106 of FIG. 1 according to an embodiment herein. The user interface view 300A depicts a welcome screen of the on-demand sports broadcasting system 106. The user interface view 300A includes one or more thumbnails tab 302A, and a view tab 304A, and a tab 306A. The view tab 304A includes a featured tab, a trending tab, a most viewed tab, and a happening now tab. When the user 102 clicks on the featured tab, features of the sport(s) and/or team(s) is displayed on the user computing device 104. When the user 102 clicks on the trending tab, latest trends on the sport(s) and/or team(s) is displayed on the user computing device 104. The most viewed tab is configured to display most viewed sport(s) and/or team(s) upon clicking on the most viewed tab by the user 102. The happening now tab is configured to display the ongoing sport(s) and/or team(s) upon clicking on the happening now tab by the user 102. The user interface 300A also includes the tab 306A that allows the user to choose a favorite sport for past, present and future games and order single or multiple games for a small fee. In one embodiment, the user may also save the favorite game or sport. In another embodiment, the user may set one or more alerts for one or more upcoming sports or games.

FIG. 3B illustrates the user interface view 300B of the one or more sports selection screen of the on-demand sports broadcasting system 106 of FIG. 1 according to an embodiment herein. The user interface view 300B depicts an option to the user 102 to select one or more sports of the user's interest on the on-demand sports broadcasting system 106. The user interface view 300B includes a soccer tab 302B, a rugby tab 304B, a tennis tab 306B, a golf tab 308B, a bike tab 310B, and/or a basketball tab 312B. When the user 102 clicks on the soccer tab 302B, the soccer sport is selected to be played on the user computing device 104. In one embodiment, the user 102 can select one or more sports and set priority of the one or more sports. In one embodiment, the selected favorite game is available 24*7, and the user may watch the favorite game live or later on.

FIG. 3C illustrates the user interface view 300C of the one or more teams selection screen of the on-demand sports broadcasting system 106 of FIG. 1 according to an embodiment herein. The user interface view 300C depicts an option to the user 102 to select the one or more teams of the selected sport(s) of the user's interest on the on-demand sports broadcasting system 106. The user interface view includes a team A1 tab 302C, a team A2 tab 304C, and a team A3 tab 306C. When the user 102 clicks on the team A1 tab 302, a game of team A1 is played on the user computing device 104.

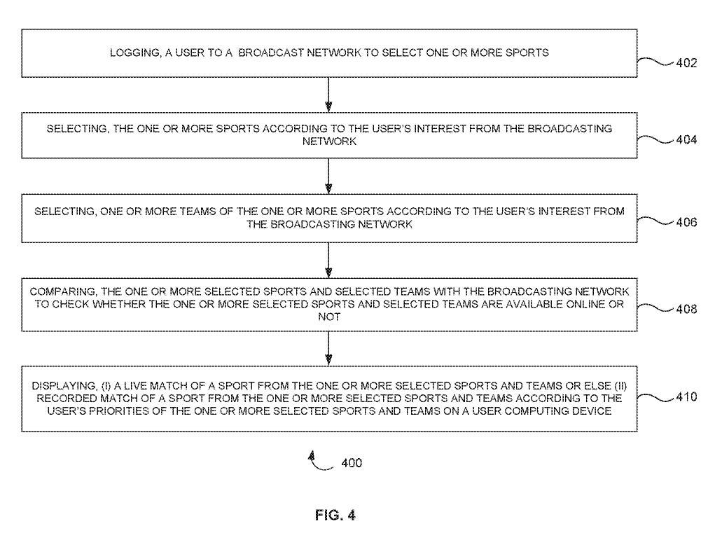

FIG. 4 is a flow diagram 400 illustrating a method of selecting the one or more sports and teams according to the user's interest for customized broadcasting for the user 102 according to an embodiment herein. In step 402, the user 102 logs into a broadcast network to select one or more sports. In step 404, the one or more sports are selected from the broadcasting network according to the user's interest. In step 406, the one or more teams of the one or more sports are selected from the broadcasting network according to the user's interest. In step 408, the one or more sports selected and the one or more teams selected are compared with the broadcasting network to check whether the one or more sports selected and the one or more teams selected are available online or not. In step 410, (a) a live match of a sport from the one or more sports selected and the one or more teams selected, or else (b) recorded match of a sport from the one or more sports selected and the one or more teams selected according to the user's priorities of the one or more sports selected and the one or more teams selected are displayed on a user computing device 104. The customer just needs to have a local cable provider, and the customer will be able to watch favorite team of any sport anywhere, unless the sport is locally or nationally televised at just a click of a button on the cable remote control.

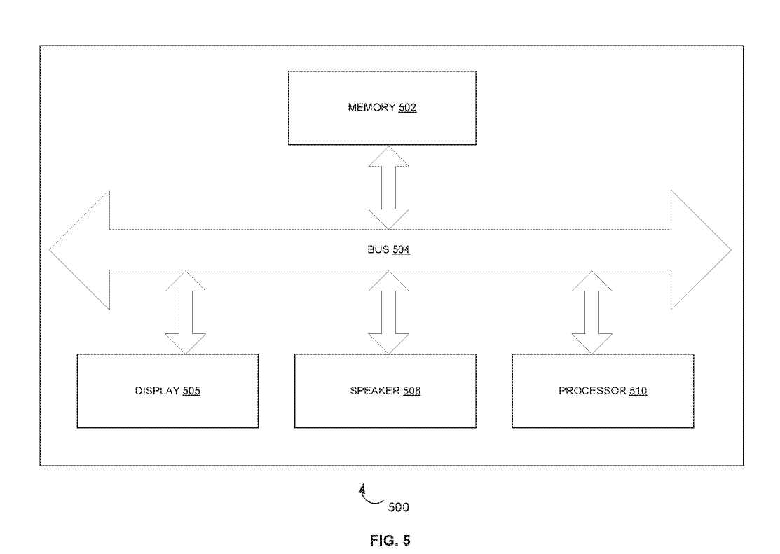

FIG. 5 illustrates an exploded view of the computing device 104 having an a memory 502 having a set of computer instructions, a bus 504, a display 505, a speaker 508, and a processor 510 capable of processing a set of instructions to perform any one or more of the methodologies herein, according to an embodiment herein. In one embodiment, the receiver may be the computing device 104. The processor 510 may also enable digital content to be consumed in the form of video for output via one or more displays 505 or audio for output via speaker and/or earphones 508. The processor 510 may also carry out the methods described herein and in accordance with the embodiments herein.

Digital content may also be stored in the memory 602 for future processing or consumption. The memory 602 may also store program specific information and/or service information (PSI/SI), including information about digital content (e.g., the detected information bits) available in the future or stored from the past. A user of the personal communication device may view this stored information on display 606 and select an item of for viewing, listening, or other uses via input, which may take the form of keypad, scroll, or other input device(s) or combinations thereof. When digital content is selected, the processor 610 may pass information. The content and PSI/SI may be passed among functions within the personal communication device using the bus 604.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

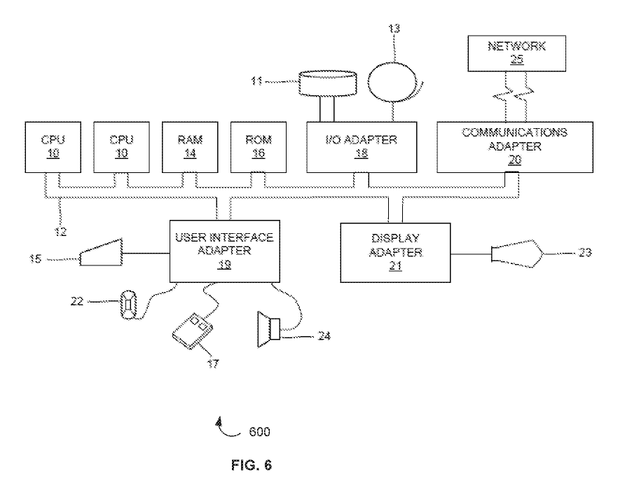

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An on-demand sports broadcasting system for selecting a plurality of user's interest sports and teams in a broadcast network, wherein said on-demand sports broadcasting system comprises:
a memory unit that is adapted to store a database, and a set of program modules;
a processor that is adapted to process said set of program modules, wherein said set of program modules comprises:
a login program module, executed by said processor, that is configured to allow said user to login into said on-demand broadcasting system;
a sport selection program module, executed by said processor, that is configured to select a plurality of sports of said user's interest and set priorities for said plurality of sports;
a team selection program module, executed by said processor, that is configured to select a plurality of teams of said plurality of selected sports and set priorities for said plurality of teams;
a processing program module, executed by said processor, that is configured to compare said plurality of selected sports, and said plurality of selected teams with broadcasting network to check whether said selected plurality of sports, and said plurality of selected teams are available online or not; and
a control program module, executed by said processor, that is configured to play (i) a live match of a sport from said plurality of selected sports and teams or else (ii) recorded match of a sport from said plurality of selected sports and teams according to said set priorities of said plurality of selected sports and teams; and
a display unit that is adapted to display (i) a live match of a sport from said plurality of selected sports and teams or else recorded match of a sport from said plurality of selected sports and teams according to said priorities of said plurality of selected sports and teams on a user computing device.

2. The on-demand sports broadcasting system of claim 1, wherein said user is allotted with a unique user ID, and a user login password to login into said on-demand sports broadcasting system.

3. The on-demand sports broadcasting system of claim 2, wherein said user login password is changed by said user.

4. The on-demand sports broadcasting system of claim 1, wherein said broadcasting network is an internet, a cable network, a comcast, a sports network, or a direct TV.

5. The on-demand sports broadcasting system of claim 1, wherein said plurality of selected sports are available on said broadcasting network for 24 hours or until next match of said plurality of selected sports are played which ever earlier.

6. A method of selecting a plurality of user's interest sports and teams in a broadcasting network for customized broadcasting for a user, wherein said method comprises:
logging a user in to said broadcast network to select a plurality of sports;
selecting said plurality of sports according to said user's interest from said broadcasting network;
selecting a plurality of teams of said plurality of sports according to said user's interest from said broadcasting network;
comparing said plurality of selected sports and selected teams with said broadcasting network to check whether said plurality of selected sports and selected teams are available online or not; and
displaying, (i) a live match of a sport from said plurality of selected sports and teams or else (ii) recorded match of a sport from said plurality of selected sports and teams according to said user's priorities of said plurality of selected sports and teams on a user computing device.

7. The method of claim 6, wherein said method further comprises:
prioritizing said plurality of sports according to said user's preference; and
prioritizing said plurality of teams of said plurality of sports according to said user's preference.

8. The method of claim 6, wherein said plurality of selected sports are available on said broadcasting network for 24 hours or until next match of said plurality of selected sports are played which ever earlier.

9. The method of claim 6, wherein said user is allotted with a unique user ID, and a user login to logging into said broadcast network to select said plurality of sports.

10. The method of claim 6, wherein said broadcasting network is an internet, a cable network, a comcast, a sports network, or a direct TV.

11. A non-transitory program storage device readable medium by a computer, and comprising a program of instruction executable by said computer to perform a method of selecting a plurality of user's interest sports and teams in a broadcasting network for customized broadcasting for a user, wherein said method comprises:
logging a user in to said broadcast network to select a plurality of sports;
selecting said plurality of sports according to said user's interest from said broadcasting network;
selecting a plurality of teams of said plurality of sports according to said user's interest from said broadcasting network;
comparing said plurality of selected sports and selected teams with said broadcasting network to check whether said plurality of selected sports and selected teams are available online or not; and
displaying (i) a live match of a sport from said plurality of selected sports and teams or else (ii) recorded match of a sport from said plurality of selected sports and teams according to said user's priorities of said plurality of selected sports and teams on a user computing device.

12. The non-transitory machine-readable medium of claim 11, wherein said method further comprises:
prioritizing said plurality of sports according to said user's preference; and
prioritizing said plurality of teams of said plurality of sports according to said user's preference.
